(19) United States
(12) Patent Application Publication
(10) Pub. No.: US 2021/0018988 A1
(43) Pub. Date: Jan. 21, 2021

(54) modifier key toggle keyboard

(71) Applicant: Alton Crawford, Brooklyn, NY (US)

(72) Inventor: Alton Crawford, Brooklyn, NY (US)

(73) Assignee: Alton Crawford, Brooklyn, NY (US)

(21) Appl. No.: 16/990,021

(22) Filed: Aug. 11, 2020

(51) Int. Cl. G06F 3/023; G06F 3/0488

(52) U.S. Cl. CPC G06F 3/023; G06F 3/04886

(57) ABSTRACT

The present invention discloses an improved method and system for receiving user input data into a computer system having a keyboard which may not have a caps lock key. The keyboard uses single instances or combinations of software and drivers with controller and/or listening apparatuses to listen for modifier keys. Upon pressing the key, the listener will hold the modifier key for the user and toggle the modifier key after the desired character or command is produced.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates generally to keyboards and touchpads, and more particularly to a keyboard. In a particular form, the present invention relates to keyboard assembly that may not have a caps lock key and takes instructions through controller or listening apparatus.

### Description of the Related Art

The origin of modern keyboards as the primary means of entering text and data from man to machine dates back to the early typewriters of the 19th century. With the development of computers, it was a natural development to improve the typewriter keyboard used as the main means for inputting text and data. The implementation of keys on typewriters and subsequent computer keyboards has evolved from mechanical to electrical and eventually to electronic, but the size, layout, and mechanical properties of the keys themselves have largely changed.

Computers have evolved from a “desktop” configuration to a more portable configuration known as a “laptop”, “notebook”, “netbook”, or “portable”. Laptop computers typically have an integrated mechanical keyboard as part of the device. This type of integrated keyboard has the advantage that it is similar in size and feel to a stand-alone keyboard typically used with desktop computers. However, by incorporating a keyboard, a portable computer has a display and a keyboard as one part. Most portable computer models employ a “folding” design, where the keyboard part forms the base and the display part forms the lid. The presence of a keyboard in a portable computer makes the size of the portable computer almost twice the size it should be.

In the past decade, a new form of portable computing device, commonly referred to as a “tablet” computer, has emerged. Typically, this type of portable computing device relies solely on touch as the primary human computer interface means instead of having an integrated keyboard. Many people believe that tablets and eventually “touch surfaces” that permeate everyday life will become the standard way for people to interact with “computers” in the future.

The transmission of alpha-numeric information from one person to another currently essentially is carried out by means of four different data entry techniques. These include sticks (chisel on stone, pencils, pens, markers, and the like), keyboards (typically used with typewriters, computers, and word processors), spatial devices (computer “mice”, track balls, joy sticks, and the like used with computers); and voice (direct human communication and voice responsive computer systems). At the present state of technology, word processors and computers primarily rely upon data entry keyboards and the various spatial devices for inputting information into the computer, electronic typewriter, or word processor for subsequent display and/or printing. Of these techniques, keyboards are the most widely used today and many computers use a combination of keyboards and spatial devices (such as the movable “mice” which have become highly popular since 1980 for example on the Apple McIntosh Computer).

The now standard keyboard character assignment used in conjunction with typewriters and computers has what is known as the “QWERTY” key arrangement. This designation is named after the top row of letters in the four-row keyboard. The “QWERTY” arrangement was invented and patented over 100 years ago and resulted from some unique characteristics of the all mechanical typewriters which existed at the time of the invention. One problem with early mechanical typewriters was that the entire force for providing the mechanical energy used to operate most of the typing function was provided by the force with which the key was struck. In addition to moving the typebar, this force also g released the carriage and moved the ribbon forward, with no other energy source.

Early keyboards utilized a simple alphabetic layout, but it was quickly discovered that the typebars of the early, crude, mechanical typewriters frequently jammed once a typist learned “QWERTY” keyboard was developed to place the most commonly used letters in English at the opposite sides of the type basket. The keyboard itself was laid out to provide direct mechanical connections to the various letters. Consequently, many of the commonly used letters were placed away from the “home” (center) row where the fingers normally rested. In addition, the “QWERTY” keyboard was designed with another slow-down technique by causing common letter pairs to be struck by the same finger on the same hand. This is the slowest motion for successive letters which could be developed. The “QWERTY” keyboard also introduced two function keys, the “CAP LOCK” and “SHIFT” keys, which allowed upper- and lower-case letters to be activated by the same keys and allowed the upper row of keys (the numbers and punctuations) to share the same keys. This was in contrast to typewriters less advanced than “QWERTY” which had eight rows of keys instead of the basic four rows for “QWERTY”. The early widespread popularity of the “QWERTY” mechanical typewriter resulted in a nearly universal adoption of the “QWERTY” keyboard layout.

The “QWERTY” keyboard continued to be used, because of widespread mastery by secretaries and data input operators, even after the reasons for its original development no longer were applicable. Electric typewriters eased the finger burden by allowing the keystroke to mechanically access an electric motor which then provided the energy to complete the mechanical process of printing and operating the other mechanism of the typewriter. Electric typewriters in turn have been replaced by electronic typewriters, word processors, and computers which completely eliminate the necessity for the inefficient “QWERTY” keyboard layout. This layout, however, has continued to dominate the market today, long after its need has disappeared. Computer keyboard buffers, which separate too quickly struck keys eliminate all of the problems which the “QWERTY” keyboard originally was designed to overcome. Efforts have been made to modify the layout of multi-key keyboards to improve efficiency.

There are multiple advancements that have been done in prior art regarding keyboards. For instance, a Dynamic keyboard bearing U.S. Pat. No. 6,359,572B1 is issued to Microsoft Technology Licensing LLC. The patent suggests an improved method and system for receiving user input data into a computer system having a keyboard with a dynamic key that changes its meaning and appearance in response to a predicted need of a user. The dynamic key is preferably provided on a displayed keyboard of a touch-sensitive input panel. Characters are provided to a prediction engine which returns a prediction comprising a likely next character, such as a punctuation symbol. The meaning and appearance of the dynamic key may change based on the prediction, whereby a user may more efficiently enter data via a fixed number of keys.

Another patent on Dynamic predictive keyboard bearing U.S. Pat. No. 5,128,672A is issued to Apple Inc. The patent is on a keyboard having the ability to predictively display different characters in association with its various keys within a variety of predefined character set layouts, based upon either the character preceding an insertion point in a corresponding text field on a display or the last character entered from the keyboard is disclosed. Although each key of the keyboard is capable of displaying numerous different characters, each key represents only one character at a time and each character is displayed at only one key location. The user can also manually change character set layouts. When a user selects a particular key or selects an insertion point within the text field, all keys are updated to display a character set layout that corresponds to the set of characters from which the user would be most likely to want to select a character from next, based upon the frequency of that particular character combination being used in either a particular language or application. The organization of the characters within each character set layout is also based on the frequency of those characters being used in either a particular language or application. The keyboard can be implemented to operate as either a touch-sensitive display or as a collection of interactive images on any of a number of different displays. The keyboard can also be used in conjunction with the special function keys or buttons that are common to computer system for performing function-character command operations.

A patent on Virtual keyboard system with automatic correction bearing U.S. Pat. No. 9,400,782B2 is issued to Nuance Communications Inc. The patent discloses an enhanced text entry system which uses word-level analysis to automatically correct inaccuracies in user keystroke entries on reduced keyboards such as those implemented on a touch-sensitive panel or display screen, or on mechanical keyboard systems. A method and system are defined which determine one or more alternate textual interpretations of each sequence of inputs detected within a designated auto-correcting keyboard region.

Another patent on Virtual keyboard system with automatic correction bearing U.S. Pat. No. 8,570,292B2 is issued to Nuance Communications Inc. The patent discloses an enhanced text entry system which uses word-level analysis to automatically correct inaccuracies in user keystroke entries on reduced keyboards such as those implemented on a touch-sensitive panel or display screen, or on mechanical keyboard systems. A method and system are defined which determine one or more alternate textual interpretations of each sequence of inputs detected within a designated auto-correcting keyboard region.

A Handheld electronic device with keyboard bearing U.S. Pat. No. 7,561,685B2 is issued to BlackBerry Ltd. The patent is on a keyboard for a handheld electronic device comprises ten keys arranged in four rows in a DTMF keypad format. Three of the keys respectively bearing numerals 1, 2 and 3 arranged in a first row, three of the keys respectively bearing numerals 4, 5 and 6 arranged in a second row, three of the keys respectively bearing numerals 7,8 and 9 arranged in a third row, and a tenth key bearing a 0 located in a fourth row. The keys of the first second and third rows also bear letter characters which, either alone or in conjunction with additional letter character-bearing keys in the rows, are positioned relative to the letter characters on adjacent keys so as to form any layout keyboard.

Another patent on Keyboard overlay for optimal touch typing on a proximity-based touch screen bearing U.S. Pat. No. 8,790,025B2 is issued to TouchFire Inc. The patent is on a keyboard overlay for use on a touch screen is disclosed, as well as novel key structures for use on overlays. The keyboard overlay and key structures have novel structures which can provide finger resting resistance, deceleration during actuation, pre-actuation cues, finger positioning cues, key identification cues, and other desired aspects of a keyboard optimized for touch typing. Methods for stowing and deploying the keyboard overlay to align with the virtual keyboard of a touch screen are also disclosed. The disclosed keyboard overlay can provide optimal touch-typing characteristics for use on all known types of touch screens.

Another patent on Virtual reality keyboard system and method bearing U.S. Pat. No. 6,388,657B1 is issued to Anthony James Francis Natoli. The patent suggests a system and method implement a virtual reality (VR) keyboard. The VR keyboard system and method receive a VR glove position, generate a corresponding key code from the VR glove position using a predetermined mapping, and send the key code to an application program as a key input corresponding to a keyboard and/or keypad entrap of data and/or a command. The system and method also generate a display representing the key input based in on the VR glove position. The display of the key input may include, but is too limited to, a displayed depressed key in a VR headset of a VR representation of a VR keyboard indicating the key input. The system and method implementing a virtual reality keyboard addresses and solves numerous difficulties of physical and/or hardware-based input devices and provides many diverse advantages in use and applications.

Another patent on Ergonomic keyboard bearing U.S. Pat. No. 5,553,953A is issued to Metamorfyx LLC. The patent is on an ergonomic keyboard having a mount and a plurality of keys arranged in a plurality of unbroken adjacent rows is provided. Each row is comprised of an arcuate portion, a left portion, and a right portion. The left and right portions extend tangentially from the left and right sides of the arcuate portion, respectively. The arcuate portion, of each row is convex to the user side of the keyboard, and at least two keys in each arcuate portion are elongated. Alphanumeric indicia on the keys can be arranged in the QWERTY pattern.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease of use ability of these assemblies is also questionable.

It has to be noted that the current invention proposes an assembly with multiple advancements including a keyboard that does not have a caps lock key. The assembly has software/drivers which can be utilized by attached or detached controller or listening apparatus to listen for the Shift key. Once the Shift key is pressed, the listener will generate a capitalized letter and toggle shift after the character is produced. This device will bridge soft keyboard and hard keyboard-based typing for a single keyboarding experience across devices.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a keyboard where keyboard uses software/drivers which can be attached/detached to controller and/or listening apparatus to listen for the Shift key.

It is another objective of the invention to provide an assembly where once the Shift key is pressed, the listener will generate a capitalized letter and toggle shift after the character is produced.

It is further the objective of the invention to provide an assembly where the proposed device will bridge soft keyboard and hard keyboard-based typing for a single keyboarding experience across devices.

It is furthermore considered that many people, particularly those having a physical or neurological disability which is manifested by poor motor coordination, may not be able to use a standard keyboard either. This type of assembly can be beneficial for such users.

It is also the objective of the invention that a standard keyboarding which is difficult to learn; requires considerable practice to master whereas the proposed assembly will bring ease in using a standard keyboard.

It is also the objective of the invention to reduce the optimum configuration with regard to frequency of keystrokes and the movement of the fingers required in operation.

A further object is to provide an assembly that is simple, rapidly adjusted and easy to use.

A still further object is to provide an assembly that is economical in cost to manufacture.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION

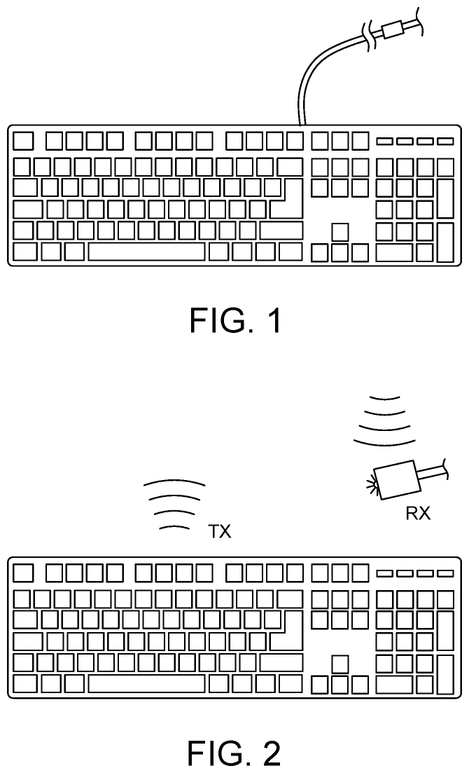

FIG. 1. Controller/listening apparatus may be arranged along the device's cable

FIG. 2. In wireless configuration, the device may be accompanied by a receiving device or used with popular wireless technology

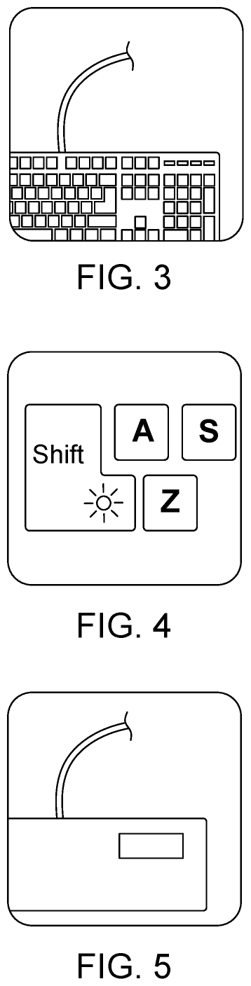

FIG. 3. The device may be used in software mode where an application or software component is responsible for producing the desired effect without the help of, or in conjunction with internal technologies

FIG. 4. Modifier keys may be accompanied by an indicator light to signal the user that they are being assisted by the device, the device may exist in any key layout

FIG. 5. Controller/listening apparatus may be hidden or compartmentalized within the device for aesthetic and/or protective purposes

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to a keyboard that may not have a caps lock key. The assembly possesses a keyboard which uses software/drivers and/or attached/detachable controller and/or listening apparatus to listen for modifier keys that include, but are not limited to, the Shift key.

As per preferred embodiments of the invention, once the modifier key is pressed, the listener will hold the modifier key to help the user generate a the desired action or character and toggle the modifier key after the character or action is produced. The proposed assembly will bridge soft keyboard and hard keyboard-based typing for a single keyboarding experience across devices. The keyboard using software/drivers will have compatibility subject to operating system, while the controller-based units should be able to operate independently of operating system.

The assembly as per additional embodiments may present an index light on modifier keys. The controller can be internal or non-visible. Furthermore, the controller may be compartmentalized. The controller may rest anywhere along the cable.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. In a computer system having a graphical user interface, a method of providing keys to a user for data input, comprising the steps of, displaying a representation of a keyboard having a fixed set of character keys that may exclude caps lock key. The keyboard uses software/drivers, and/or controller and/or listening apparatus to listen for modifier keys. Once the modifier key is pressed, the listener will generate the desired character, action or command and toggle the modifier key after the result is produced.

2. A text entry system comprising:
an auto-correcting keyboard region comprising a plurality of the characters of an alphabet, each of said characters having a contact location within said keyboard region;
an alphanumeric evaluation component which identifies at least one alphanumeric object, and for any identified candidate object, evaluates said identified object by calculating a matching metric;
wherein when the function of said object can be changed by using a modifier key and
wherein the characters of the alphabet or language are arranged on the auto-correcting keyboard region in approximately a standard layout.
